(19) United States
(12) Patent Application Publication
(10) Pub. No.: US 2024/0357015 A1
(43) Pub. Date: Oct. 24, 2024

(54) METHOD AND SYSTEM FOR CREATING USER ACCOUNTS AND ESTABLISHING A COMMUNICATION LINK BETWEEN TWO USERS

(71) Applicant: Onoff Telecom, Paris (FR)

(72) Inventor: Taïg KHRIS, PARIS (FR)

(21) Appl. No.: 18/138,028

(22) Filed: Apr. 21, 2023

(51) Int. Cl. H04L 67/306; H04L 67/53

(52) U.S. Cl. CPC H04L 67/306; H04L 67/53

(57) ABSTRACT

The present invention relates to a method and system for creating one or more user accounts with at least a first communication service provider, wherein a first user places a request with a processing server, selects a telephone number from a plurality of proposed numbers, said selected number becoming the identifier of the user account. The invention also relates to a method and system for establishing a communication link between a first user and a second user wherein the first user logs in with the selected telephone number to the first communication service provider and initiates a communication, of the telephone type, with a second user.

### OBJECT OF THE INVENTION

The present invention relates to a method and system for creating one or more user accounts, for one or more communication services or one or more communication software applications, and a method and system for establishing a communication link between a first account of a first user and a second account of a second user.

### STATE OF THE ART

The communication between two users is usually done with the help of communication terminals, which are usually mobile and portable devices, in particular smartphones, comprising communication means, usually wireless, allowing it to make and receive telephone calls, send and receive messages, short messages of the SMS (Short Message Service) type and multimedia messages of the MMS (Multimedia Messaging Service) type, and also to send and receive computer data. Generally, each of these mobile communication devices is linked to a so-called “physical” telephone number, because it is associated with the SIM card used by the smartphone, a SIM card that is affiliated with a particular telephone operator, and therefore linked to the latter's communication network.

Thus, this communication can be done conventionally via the mobile telephone network of the telephone operator, by the establishment of a “classic” telephone link between the physical number of the first user and that of the second user, or with the help of a communication software application (APL) and the establishment of a data communication link via the telephone communication network or an Internet communication network, wired or wireless, for example a WIFI network, allowing the transmission, between the two users, of data comprising text, audio or video content, and also voice, also called “Voice over IP”.

For users who need more than one telephone number for their telephone communications when using a mobile telephone network, it is possible to have another number, assigned by a telephone operator, through the use of a second SIM card to which said number is associated, which the user can use in his mobile communication device, if this is available; otherwise a second mobile communication device must be used. However, this solution has the disadvantage of not being suitable for all mobile communication devices, and of not being able to have more than two different numbers. It has been proposed to use eSIM cards, and the user can have several of them in his smartphone and can therefore have several telephone subscriptions (each billed by communication minutes, by quantity of SMS, MMS, or by volume of data and each having its own number). In addition, so-called “virtual” telephone numbers have been proposed, as they are not associated or linked to a SIM card or an eSIM card. These virtual numbers are national, regional or international, fixed and mobile numbers, allocated to a telephony operator, whether or not it operates a telecommunications network, by the relevant national communications regulatory authority or authorities; this allocation is carried out in the traditional way, as for physical numbers. These virtual numbers have the advantage of being usable with or without a SIM/eSIM card, on a single mobile communication device, and can be used simultaneously on other mobile communication devices as well.

The use of one or more virtual numbers has many other advantages. For example, the use of virtual numbers can provide a solution for maintaining a good quality of communication between two users.

With respect to communications using a data communication link, there are many communication services or APLs implemented on communication devices that use a cell phone network and/or an Internet communication network to broadcast, transmit and receive content, including voice over IP. This is the case, for example, of the WhatsApp (Registered Trademark) application.

A user who wishes to use such a service or a communication APL must first create a user account with the said service or APL. This account creation requires the user's cell phone number, assigned by an operator via a SIM card, eSIM or virtual number service, to be filled in, and implements a validation process, which generally involves receiving an SMS with a validation code or link after dialing his number on the communication service.

However, there are multiple other validation systems: creation of a password composed of letters and numbers, receipt of an email with a validation link or code, facial recognition, fingerprint recognition, etc.

Regardless of the account validation method used, once the validation is complete, the user can finish creating his account by adding any personal information; the user's account is then created and secured, and assigned a unique identifier. The user will then be able to make and receive audio and video calls, write and receive messages and send media, but only to other users of the same communication APL. The user's account ID, visible to all users of the APL, is then usually the number of the user's mobile communication device that validated the account via the validation code or link received via SMS.

Some communication APLs allow the user, after the validation of his account, to create a unique identifier, different from the mobile number used to validate the account, which can be composed of letters and numbers. However, in general, the cell phone number, which was used to create the account and which is linked to the user account, is the user's identifier, and therefore cannot be used to open another account for the service or in the APL in question.

In addition, these solutions have the disadvantages of not allowing the user to choose, in the communication APL on which he wishes to create a user account, the mobile number that will serve as the account identifier for this communication APL, of obliging the user to obtain a mobile number assigned to a SIM card, eSIM or virtual number from a telephony operator, and of not allowing a user of a communication APL to make a call or receive a call from a user of another communication APL.

### Aims of the Invention

It is an object of the present invention to provide a method and system for creating one or more user accounts, and a method and system for establishing a communication link between a first user and a second user, that do not have the drawbacks of the prior art.

The present invention is intended to provide an alternative to existing prior art solutions.

The present invention is intended to provide a solution that is easily, quickly, flexibly and reliably implemented.

### SUMMARY OF THE INVENTION

The present invention relates to a method for creating one or more user accounts with at least a first communication service provider. The method includes the steps of:
placing a user account creation request with the first communication service provider by a first user using a communication device,
receipt of the request by a processing server of the first communication service provider,
presentation, by the processing server, to the first user, of one or more lists of telephone numbers, each comprising at least one telephone number, having the format of a fixed telephone number or a mobile telephone number, national, regional or international,
selection, by the first user, of a telephone number in the list(s) of telephone numbers,
the creation of the first user's user account with the first communication service provider, and
assigning the phone number, selected by the first user, as the unique identifier of the user account.

According to preferred modes of the invention, the method of creating one or more user accounts according to the invention comprises at least one, or any suitable combination, of the following features:
the communication device is a fixed telephone,
the request for user account creation is made by the communication software application or via an Internet page of the first communication service provider,
the proposed phone list(s) was obtained from a third party provider,
before the step of presenting one or more telephone lists, a step of proposal to the first user to identify himself by a pre-existing number is added,
the method further comprises one or more steps of validation of the user account to be created, including means of authentication of the first user's communication device, validation by e-mail, SMS, fingerprint recognition, facial recognition, creation of a password, and a combination thereof,
said validation steps occur before the step of presenting one or more lists of telephone numbers,
the method further comprises one or more steps of securing the user account created by the first user with the first communication service provider,
after the creation step, a step of deleting the account is added, followed by a step of making said telephone number available again in the list of numbers for possible further requests,
the method further comprises creating, by the first user, one or more additional accounts with the first communication service provider, by placing a new user account creation request with the first communication service provider, by the first user, using a communication device, receiving the new request by the processing server, presenting, by the processing server, to the first user, one or more lists of telephone numbers each including at least one telephone number, selecting, by the first user, a new telephone number from the one or more lists of telephone numbers, creating the new user account of the first user with the first communications service provider, and assigning the new telephone number selected by the first user as a login identifier for the new user account, wherein the first user already has a first user account with the first communications service provider.
the first user already has a first user account with the first communication service provider.

The present invention also relates to a system for implementing the method of creating one or more user accounts according to the invention, the system comprising a first user provided with a communication device, a first communication service provider, comprising one or more software applications and/or one or more Internet sites, one or more processing servers, proposing one or more lists of telephone numbers and allowing the creation of a user account, having as an identifier one of the proposed telephone numbers, the system further comprising one or more telephonic communication networks, allowing data communication and/or one or more Internet networks.

In a particular embodiment of the invention, the system for creating one or more user accounts further comprises a third party provider supplying, to the first communication service provider, the telephone numbers of the one or more lists, presented to the first user.

The present invention also relates to a method of establishing a communication link between a first user and a second user, which comprises the steps of creating, by a first user, a user account with a first communication service provider, by implementing the method of creating the user account(s) according to the invention, connecting the first user to his user account with the first communication service provider by means of a communication device and using the telephone number selected from the first communication service provider, initiating, by the first user, a communication with the second user, in order to establish a telephone-type communication link between the first user and the second user.

According to preferred modes of the invention, the method of establishing a communication link according to the invention comprises at least one, or any suitable combination, of the following features:
a step of activation of the telephone number, selected by the first user, is added with a third party provider if the third party provider has provided the telephone numbers proposed to the first user, and/or with one or several telephone operators,
the communication includes the exchange of voice, images, video, and a combination of these,
a disconnection step is added after the account creation step, and before the connection step; in such a situation, one benefits from the advantage of the invention which allows to reconnect in the absence of any GSM type network, but only with an internet connection.

The present invention also relates to a system for implementing the method of establishing a communication link according to the invention, the system comprising
a first user with a communication device,
a first communication service provider, comprising one or more software applications and/or one or more Internet pages,
one or more processing servers, proposing one or more lists of telephone numbers and allowing the creation of a user account, having as identifier one of the proposed telephone numbers,
at least one second communication service provider
one or more telephone communication networks, allowing data communication and/or one or more Internet networks, and
one or more operators running said network(s).

### BRIEF DESCRIPTION OF THE FIGURES

FIG. 1 is a schematic representation of the process for creating a user account according to the invention.

FIG. 2 is a schematic representation of the method for establishing a communication link according to the invention.

### DETAILED DESCRIPTION OF THE INVENTION

For the remainder of the description and claims, the following terms are defined:

A “communication service provider” is any entity that provides computer facilities for communication between two users, such as a web page or a communication software application (see below).

A “communication device” refers to any electronic device, including any computer or telephone, preferably portable, such as a “smartphone”, capable of transmitting and receiving telephone communications and data, via a telephone communication network and/or a data communication network, whether wired or wireless.

A “Server” means a device or a set of devices or means, including hardware and software, storage and processing means, executing operations following requests, and including long distance communication means able to communicate, in reception and transmission, with one or more mobile communication devices.

A “computer” means any device, including a connected object, provided with software and hardware means, which is capable of receiving, sending and processing computer data, and capable of communicating through a data communication network, such as the Internet.

A “communication software application” means a software application comprising software means, implementable by any communication device.

The abbreviation “APL” refers to a software application, whether or not it is a communications application.

The term “telephone communication network” refers to any infrastructure, system or set of means, devices and/or computers, establishing radio links for telephone calls and data communication, in that it includes one or more networks of the GSM, UMTS or LTE type.

The term “Internet communication network” sometimes abbreviated to “Internet network” refers to any infrastructure, system or set of means, devices and/or computers, using the IP protocol.

Without being limiting, the present invention is described for its implementation using a mobile communication device, of the smartphone type, without however excluding the embodiments in which the communication device is not a mobile device, but a fixed device, such as for example a computer or a connected object. Moreover, the invention is described for the use of one or more communication services, in particular for a communication APL, nevertheless, it can be implemented for services, and APLs, having to do with other technical fields.

The present invention relates to a method of creating one or more user accounts by at least a first user, who may or may not already have a user account with that first communication service provider.

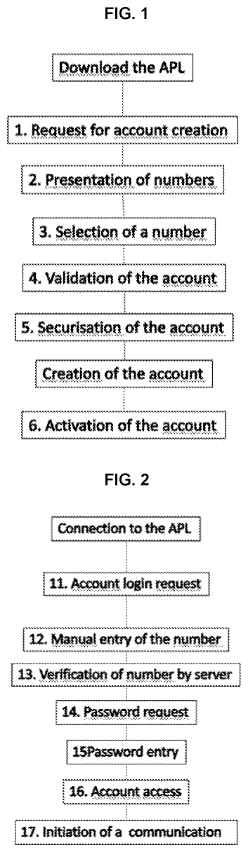

The method according to the invention includes the step of creating a user account (FIG. 1), which may be a first account or an additional account. This step comprises a request for account creation (step 1), according to methods known to the skilled person, to the first communication service provider, using a communication device, a mobile device, a telephone and/or a computer for example, using a data communication network or the Internet, via the communication APL loaded on its communication device, or via a web page of the Internet site of said first communication service provider, displayed by an Internet browser operated for example on the computer, implementing a data communication network or the Internet.

Preferably, the first communication service provider is an entity that is distinct from, and independent of, the operator of the communication network, used by the first user for such telephone calls, whether it is a telephone operator or an Internet service provider, having the network infrastructure.

The request is received by a server, operated and/or controlled, by the first communication service provider, which is a remote server. In response to this request, the processing server presents (step 2), to said first user one or more lists, comprising one or more telephone numbers having the format of a national, regional or international landline telephone number or mobile telephone number. Preferably, these are virtual numbers, not linked to a physical SIM card.

The method may include a prior step of determining the geographical location of the first user, in order to provide him with one or more lists of national numbers corresponding to this location.

These proposed telephone numbers are obtained by the first provider from the relevant communications regulator, preferably from a third party provider, which is not the communications service provider, or a telephone operator, and which has obtained them from the relevant communications regulator.

Preferably, these telephone numbers are provided to the first or third party communications service provider in the form of indicator ranges, with numbers generated within these ranges.

The first user then selects (step 3) a number from the list(s) of telephone numbers, offered by the server of the first provider.

In response to the first user's selection of the phone number, the processing server may propose one or more validation processes (step 4) for the account creation, which may be implemented by the first provider of the communication service or APL, or by a third party. The process(es) includes, for example, means of authentication of the user's communication device, such as fingerprint recognition or facial recognition, or validation by e-mail, or validation by SMS and/or by entering a password, stored in a server and associated with the virtual telephone number. Preferably this password can be requested from the user, so that he can connect to the service or to the APL.

Preferably, the validation (step 4) by e-mail comprises the step in which the first user fills in a correspondence e-mail address, when placing the account creation request, or after choosing the validation mode. The communication service provider sends a message, via a communication network, comprising a validation code to be filled in and sent to the server of the APL provider, or a link referring to a URL, for example of the provider's website or of the server, and on which the first user must click, to confirm the creation of the account.

Preferably, the validation (step 4) by SMS comprises a step in which the first user enters a telephone number, when placing the user account creation request, or after choosing the validation mode, and the server of the communication service provider, or a third party sends, via the telephone communication network, an SMS, including a validation code to be filled in the APL of the first provider or on its website, or a link referring to an URL, for example of the providers website or of the processing server, and on which the first user must click, to confirm the creation of the user account.

In embodiments in which the first user already has a first user account, which has been identified using his physical phone number, for example linked to his SIM card, the validation SMS may be sent to this physical phone number. It can then be foreseen that the account creation process according to the invention does not implement any validation steps for the new user account. This has the advantage of simplifying and accelerating the creation of user accounts for the first user whose first account has already been validated.

In another embodiment, the SMS validation phone number is the number chosen by the first user upon proposal from the first communication service provider. The validation SMS is then sent by the first communication service provider, or a third party, via a telephone communication network, to the first user, via the communication APL of the provider that provided the telephone number, for a validation similar to the one described above.

After this possible validation step, the server of the first communication service provider removes the number chosen by the first user from the list(s) of available numbers, and binds this number to the user account of the first user, which becomes his user account identifier.

The method of the invention may contain a step 5 of securing the user account. Such a securing step may include a step of identifying the user, for example by identity card or passport.

The server of the first provider activates (step 6), or causes to be activated, the telephone number selected by the first user, from the third-party provider that provided the made-available telephone numbers or from a telephone operator.

The method of creating user accounts according to the invention has the advantage of allowing a user to create an account with a communication service provider without first having a telephone number; if he already has a telephone number, the advantage is to be able to create an account with a second communication service provider, or to have several user accounts with a single communication service provider. The method according to the invention also has the advantage of allowing the user not to use as an identifier, information that he does not wish to use, for example his physical telephone number if he has one, while allowing him to be identified or found in the communication APL by other users of the APL.

The user account creation method according to the invention may further comprise a step of creating one or more additional accounts, with the first communication service provider. Preferably, this-or these-new user account creation is done in the same manner as described for the first user account. The first user places an additional request to the first communication service provider and chooses another telephone number from the list(s) proposed by the first provider, which becomes, after a possible validation procedure as described above, his user account identifier. Thus the first user can create as many different user accounts as there are telephone numbers proposed and/or authorized by the first provider.

Preferably, the creation of the additional account(s) of the first user is not accompanied by a validation procedure for each additional account creation, as the first user account has already been validated by the first communication service provider. This has the advantage of simplifying and accelerating the creation of user accounts. Nevertheless, the process of creating the additional account(s) may include one or more steps to secure said additional user accounts.

Thus, the method according to the invention has the advantage of allowing a user to possess, and to be able to use, simultaneously, several distinct accounts, because identified as such. This is particularly advantageous for the use of services or APLs from communication providers that offer different versions, sometimes with different and/or improved functionalities, of their service or APL, such as providers with a general public version and a Business version of their service or APL.

The system for creating one or more user accounts according to the invention, implementing the method for creating one or more user accounts, comprises
a first user with a communication device, preferably mobile,
a telephone and/or a computer,
a first communication service provider comprising one or more communication APLs and/or one or more Internet sites,
one or more servers for processing user account creation requests, capable of creating user accounts, proposing one or more lists of telephone numbers, and allowing the creation of a user account with one of the proposed telephone numbers as its identifier,
one or more telephone communication networks, allowing data communication and/or one or more Internet networks,
one or more operators operating said network(s), and possibly
a third-party provider of telephone numbers for the creation of the user account(s).

Preferably, the system according to the invention comprises means for generating telephone numbers, advantageously within indicator ranges provided by the relevant regulatory authority or authorities.

The method of establishing a communication link between a first user and a second user, according to the invention, comprises the process of creating the user account(s) according to the invention (steps 1 to 3, and optionally 4, 5, and/or 6) and the step in which the first user logs in to the communication service or APL of the first provider, using his or her identifier thus created. This may occur according to the following steps (FIG. 2):
account login request, step 11
manual entry of the number obtained during the creation of the account, step 12
verification of the number by the server, step 13,
the server sends a password request, step 14
the first user enters his password, step 15
account access, step 16
initiation of a communication with the second user, step 17.

Such a method has the advantage over the previous art that it is possible for the first user to connect to his account, and to initiate a communication, in the absence of a GSM type network, with only an internet network.

The first user may optionally search for the ID of the second user or other users with whom he or she wishes to communicate.

The first user initiates communication with the second user, or other users, via the first provider's service or APL, for users using and connected to the first provider's service or APL.

Preferably, the establishment of the communication implements the communication means of the first communication service provider, advantageously also those of one or more telephone or Internet operators. This then leads to the establishment of a link, either telephone or data communication, for a communication that may comprise the exchange, in sending and receiving, of voice, images, videos, and a combination thereof.

Thus, the method of creating the user account(s) according to the invention has the advantage of allowing not only to establish communication between two users using the same service or communication APL of the first provider, but also to establish communication between two users using two different service or communication APL providers, while providing the first user with the possibility of not using as a connection identifier information that he does not want to appear. This also has the advantage of not multiplying the communication services or APLs to be able to communicate with their contact, a single service or APL allowing to contact all the contacts of a user, and to allow each user the choice of his communication service provider.

The system for establishing a communication link according to the invention, implementing the method, comprises
a first user with a communication device, preferably a mobile, a telephone and/or a computer,
a first communication service provider comprising one or more communication APLs and/or one or more Internet sites, and at least a second, preferably several other, communication service provider, for example a telephone operator or an Internet service provider, or the provider who supplied the telephone numbers offered by the first communication service provider,
one or more telephone communication networks allowing data communication and/or one or more Internet networks,
one or more operators operating said network(s).

1. A method of creating one or more user accounts with at least a first communication service provider, said method comprising the following steps:
placing a user account creation request with said first communication service provider by a first user, using a communication device;
receiving said request by a processing server of said first communication service provider;
presentation of one or more lists of telephone numbers by said processing server to said first user, said one or more lists of telephone numbers comprising at least one telephone number for said first user to select, said at least one telephone number having the format of a national, regional or international, landline or mobile telephone number, wherein said one or more lists of telephone numbers contains only telephone numbers that are not allocated by a telecom operator at the time said one or more lists of telephone numbers are presented;
selection of a first telephone number from said one or more lists of telephone numbers by said first user; and
creating a user account for said first user with said first communication service provider and assigning said first telephone number selected by said first user to said user account.

2. The method of claim 1, wherein said communication device is a landline telephone.

3. The method of claim 1, wherein said first communication service provider is a web page or a communication software application.

4. The method of claim 1, wherein said one or more lists of telephone numbers are provided by a third party telecom provider.

5. The method of claim 1, further comprising proposing a pre-existing telephone number associated with said first user for said first user to enter or select before the step of presenting one or more telephone lists.

6. The method according to claim 1, further comprising one or more validation step of said user account to be created, wherein said one or more validation step is authentication of said first user's communication device, validation by said first user's e-mail, validation by SMS to said first user's mobile device, validation by fingerprint recognition using said first user's communication device, validation by facial recognition using said first user's communication device, validation by password creation by said first user, or combinations thereof.

7. The method of claim 5, wherein said validation step occurs prior to the step (2) of presenting said one or more lists of telephone numbers.

8. The method of claim 1, further comprising one or more steps of securing said created user account.

9. The method of claim 1, further comprising, after the step of creating said first user's said user account, a step of deleting said first user's said user account, followed by a step of making said first telephone number available for possible further requests.

10. The method of claim 1, further comprising creating, by the first user, one or more additional accounts with said first communication service provider, said method comprising the following steps:
placing a new user account creation request with said first communication service provider by said first user using a communication device;
receipt of said new request by the processing server;
presentation of one or more lists of telephone numbers by said processing server to said first user, said one or more lists of telephone numbers said one or more lists of telephone numbers having at least one telephone number for said first user to select, said at least one telephone number having the format of a national, regional or international, landline or mobile telephone number, wherein said one or more lists of telephone numbers contains only telephone numbers that are not allocated by a telecom operator at the time said one or more lists of telephone numbers are presented;
selection, by said first user, of a second telephone number from said one or more lists of telephone numbers by said first user; and
creating a new user account for said first user with the first communication service provider and assigning said new telephone number selected by said first user to said new user account.

11. The method of claim 1, wherein said first user already has at least one user account with said first communication service provider prior to creation of said first user account.

12. A method of establishing a communication link between a first user and a second user, comprising the following steps:
creating, by a first user, a user account with a first communication service provider, by implementing the method of creating one or more user account according to claim 1;
connection of said first user to said first user's user account with said first communication service provider and using said first telephone number assigned to said first user's user account and
initiation, by said first user, of a communication with said second user, for the establishment of a telephone-type communication link between said first user and said second user.

13. The method according to claim 12, further comprising a step of activating said first telephone number selected by said first user, with a third party telecom provider, and/or one or more telephone operators.

14. The method of claim 12, wherein the communication comprises exchanging voice, images, video, or combinations thereof.

15. The method of claim 12, wherein a logout step is added after the step of creating an account, and before the log in step.

16. A system for establishing a communication link between a first user and a second user for implementing the method of claim 12, said system comprising:
a first user with a communication device;
a first communication service provider, comprising one or more software applications and/or one or more Internet pages;
one or more processing servers, proposing one or more lists of telephone numbers and allowing the creation of a user account, having as identifier said telephone number selected by said first user from said one or more lists of telephone numbers containing only telephone numbers that are not allocated by a telecom operator at the time said one or more lists of telephone numbers are presented;
at least one second communication service provider;
one or more telephone communication networks, network allowing data communication and/or one or more Internet network; and
one or more operators running said telephone communication network.

17. The method of claim 1, wherein the said one or more lists of telephone numbers contains only telephone numbers that are not allocated by a telecom operator at the time said one or more lists of telephone numbers are presented, further includes telephone numbers which are not already associated with a SIM, eSIM, or virtual number.

18. The method of claim 12, wherein the said one or more lists of telephone numbers contains only telephone numbers that are not allocated by a telecom operator at the time said one or more lists of telephone numbers are presented, further includes telephone numbers which are not already associated with a SIM, eSIM, or virtual number.
